(19) United States
(12) Patent Application Publication
(10) Pub. No.: US 2008/0297081 A1
(43) Pub. Date: Dec. 4, 2008

(54) Brushless motor driving apparatus

(75) Inventors: Toru Morita, Chiryu-shi (JP); Tsutomu Ikeda, Tokoname-shi (JP); Yasushi Shinojima, Toyota-shi (JP); Yasutoshi Sugiura, Nishio-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-Shi (JP)

(21) Appl. No.: 12/153,870

(22) Filed: May 27, 2008

(30) Foreign Application Priority Data
May 30, 2007 (JP) 2007-142893

(51) Int. Cl. H02P 6/20

(52) U.S. Cl. 318/400.11; 903/902

(57) ABSTRACT

In a brushless motor driving apparatus, a drive circuit arranged to rotate a magnet rotor by sequentially switching energization of coils of phases, detect a position of the magnet rotor based on back electromotive force voltage generated in each phase coil, and control the energization of each phase coil based on the detected position. The drive circuit is configured to energize each phase under duty control and, before the back electromotive force control, perform initial setting twice sequentially for sweeping energization duty with respect to each phase coil to set the magnet rotor in a predetermined initial position.

### BACKGROUND OF THE INVENTION

1. Field of the Invention

The present invention relates to a brushless motor driving apparatus which executes back electromotive force drive control using a sensorless drive system.

2. Description of Related Art

There has heretofore been known a brushless motor using a sensor for detecting a magnetic pole position of a magnet rotor. On the other hand, another brushless motor has also been known which adopts a sensorless drive system of executing “back electromotive force drive” control, which is achieved by detecting a voltage signal (back electromotive force voltage) induced in each coil of a stator when a magnet rotor is rotated and generating an energization signal for a motor based on a detection signal, instead of using a sensor to detect a magnetic pole position. Herein, it is to be noted that the back electromotive force (back emf.) voltage is an induced voltage that occurs in a stator wiring when a magnet rotor (a permanent magnet) is rotated. However, the voltage signal is induced in each coil only while the magnet rotor is rotating. During non-operation of the motor, no voltage is induced in each coil. Thus, positional information of the magnet rotor is not obtained. At the time of activation of the motor, the magnet rotor has to be forcibly rotated, that is, to be forcibly driven (“forced drive” control).

JP2004-248387A discloses a brushless motor driving apparatus of a sensorless drive system of forcibly driving a motor at the time of activation thereof. This apparatus is arranged to drivingly control the motor by increasing the frequency and a duty ratio at a predetermined pattern so that the number of back electromotive force drive operations is equal to or less than the number of forced drive operations when the motor is switched from the forced drive mode to the back electromotive force drive mode upon activation of the motor. After a lapse of a predetermined time of the forced drive mode, the operation of the motor is induced based on the position of the magnet rotor.

However, in the driving apparatus arranged to perform the forced drive operation at the motor start-up, if an inappropriate coil phase is energized in the forced drive mode, the magnet rotor could not be rotated and thus back electromotive force voltage is not generated. Consequently, the brushless motor could not be activated. In the driving apparatus disclosed in JP'387A, a coil of a specific phase is energized at an initial stage to determine the position of the magnet rotor (initial setting), and then a coil of an appropriate phase is energized. However, this driving apparatus does not take sufficient measures against the problem that the motor is not activated depending on the position of the magnet rotor at the initial stage, and hence may cause malfunction of the motor. For example, in moving to a target position, the magnet rotor may go over the target position by impulse or contrary the magnet rotor may rotate too slowly and therefore the forced drive mode starts before the magnet rotor reaches the target position. In such cases, the brushless motor could not be activated. In the forced drive mode, the brushless motor also could not be activated due to inappropriate energization period of time and unsuitable energization timing.

### SUMMARY OF THE INVENTION

The present invention has been made in view of the above circumstances and has an object to provide a brushless motor driving apparatus capable of enabling activation of a brushless motor irrespective of the position at which a magnet rotor is stopped.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a brushless motor driving apparatus for driving a brushless motor comprising a stator including coils of multiple phases and a magnet rotor provided corresponding to the stator, the apparatus being arranged to rotate the magnet rotor by sequentially switching energization of each phase coil, detect a position of the magnet rotor based on back electromotive force voltage generated in each phase coil, and control the energization of each phase coil based on the detected position, wherein the apparatus is configured to energize each phase coil under duty control and, before the back electromotive force control, perform initial setting for sweeping energization duty with respect to each phase coil to set the magnet rotor in a predetermined initial position.

According to another aspect, the invention provides a brushless motor driving apparatus for driving a brushless motor comprising a stator including coils of three phases and a magnet rotor provided corresponding to the stator?, the apparatus being arranged to rotate the magnet rotor by sequentially switching energization of each phase coil, detect a position of the magnet rotor based on back electromotive force voltage generated in each phase coil, and control the energization of each phase coil based on the detected position, wherein the apparatus is configured to energize each phase coil under duty control and, before the back electromotive force control, perform initial setting at least twice for sweeping energization duty with respect to each phase coil to set the magnet rotor in a predetermined initial position.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is an electric circuit diagram showing configurations of a brushless motor and a controller thereof;

FIG. 2 is a conceptual diagram showing control logic;

FIG. 3 is a time chart showing variations in energization duty value to each coil of the phases;

FIG. 4 is a flowchart showing changes of energized phases;

FIGS. 5A to 5F are conceptual diagrams showing a positional relationship between a stator and a magnet rotor in a motor stop state;

FIG. 6 is a conceptual diagram showing changes of energized phases and changes in the positional relationship between the stator and the magnet rotor;

FIG. 7 is a time chart showing energization timing of each phase in an back electromotive force drive mode and variations in back electromotive force voltage in each phase;

FIG. 8 is a time chart showing variations in terminal voltage of the coils of the phases;

FIGS. 9A and 9B are conceptual diagrams showing a positional relationship between a stator and a magnet rotor in the motor stop state;

FIGS. 10A and 10B are conceptual diagrams showing positional relationships between a stator and a magnet rotor after first initial setting and after second initial setting respectively;

FIGS. 11A and 11B are conceptual diagrams showing positional relationships between a stator and a magnet rotor before energization from W to V phases;

FIG. 12 is a conceptual diagram showing control logic;

FIG. 13 is a flowchart showing changes of energized phases; and

FIG. 14 is a sectional view of a water pump.

### DETAILED DESCRIPTION OF THE PREFERRED EMBODIMENTS

A detailed description of a preferred embodiment of a brushless motor driving apparatus embodying the present invention will now be given referring to the accompanying drawings.

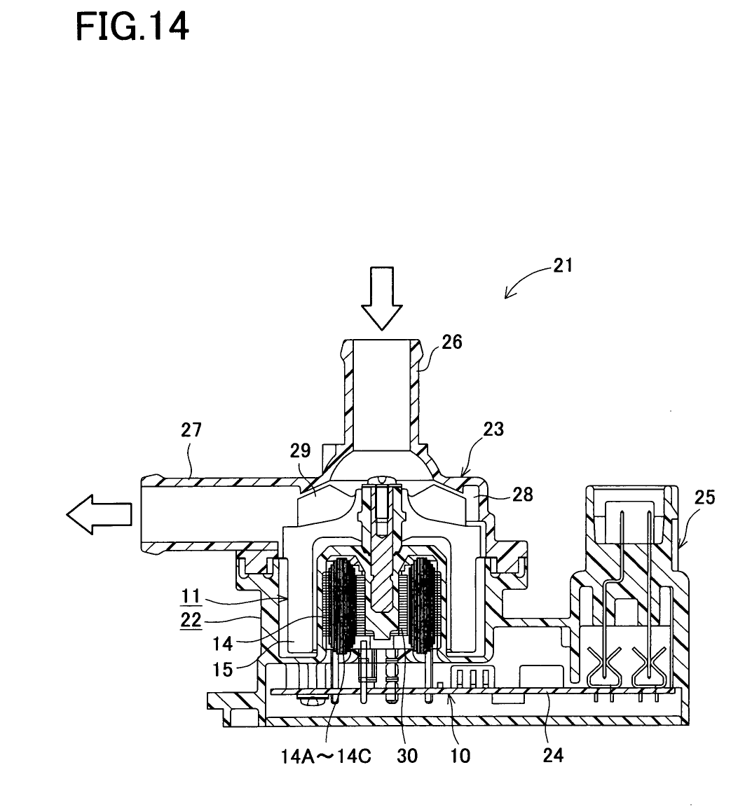

This embodiment will be explained about a driving apparatus of a brushless motor to be used in a motor-driven water pump in an engine cooling device. This water pump will be used in a hybrid electric vehicle or an electric vehicle. FIG. 14 shows a sectional view of this water pump 21. The water pump 21 includes a pump part 23, a controller 10, and a connector 25 for power supply, which are integrally provided in a single casing 22. The pump part 23 is constituted of a suction pipe 26, a discharge pipe 27, a pump chamber 28 communicating with the suction pipe 26 and the discharge pipe 27 respectively, a fin 29 that is provided integral with a magnet rotor 15 and is rotatable in the pump chamber 28, and a brushless motor 11 serving as a power source. The brushless motor 11 includes a stator 14 and the magnet rotor 15 rotatably around the stator 14. The stator 14 includes multiple phases U, V, and W having a U phase coil 14A, a V phase coil 14B, and a W phase coil 14C respectively, which are mounted on a stator core 30. The magnet rotor 15 is provided integral with the fin 29 as mentioned above and is rotatable around the stator 14. Rotation of the magnet rotor 15 around the stator 14 causes the fin 29 to rotate in the pump chamber 28, thereby sucking water into the pump chamber 28 through the suction pipe 26 and discharging the water out of the pump 21 through the discharge pipe 27. The controller 10 is configured to control the brushless motor 11 and constituted of a circuit board 24 with various electronic components. The connector 25 is connected to an external power wire to supply electric power to the brushless motor 11 and the controller 10.

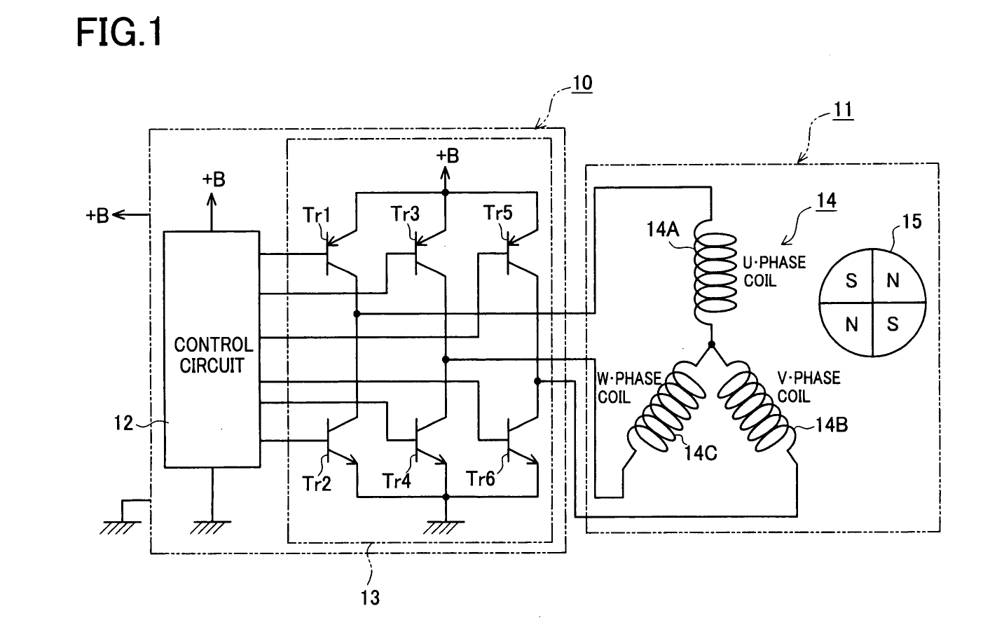

FIG. 1 is an electric circuit diagram showing configurations of the brushless motor 11 used in the water pump 21 and the controller 10 thereof. The controller 10 corresponding to a driving apparatus of the invention includes a control circuit 12 and a drive circuit 23. In this embodiment, the brushless motor 11 is a three-phase motor and the drive circuit 13 is a circuit adopting a three-phase full-wave drive system. The brushless motor 11 is configured to detect the angular position of the magnet rotor 15 (a rotor position) by utilizing back electromotive force voltage (generated voltage) produced in each of the coils 14A, 14B, and 14C of multiple phases (U phase, V phase, and W phase) of the stator 14 constituting the brushless motor 11, without using a hall element. Specifically, the brushless motor 11 is arranged to detect the rotor position based on the back electromotive force voltage generated by the rotation of the magnet rotor 15 that is also a movable member of the water pump 21 and determine the phase coils 14A to 14C to be energized. However, no back electromotive force voltage is generated at start-up and thus the magnet rotor 15 is caused to rotate by “initial setting” and “forced drive” control (mode). After the back electromotive force voltage is generated by the forced drive control, this forced drive control (mode) is switched to the “back electromotive force drive” control (mode) which is carried out by detecting the back electromotive force voltage.

As shown in FIG. 1, the drive circuit 13 is constituted by first, third, and fifth transistors Tr1, Tr3, and Tr5 of PNP type as switching elements and second, fourth, and sixth transistors Tr2, Tr4, and Tr6 of NPN type as switching elements, which are connected in three-phase bridge configuration. The first, third, and fifth transistors Tr1, Tr3, and Tr5 have emitters which are connected respectively to a power supply terminal (+Ba) of the controller 10, while the second, fourth, and sixth transistors Tr2, Tr4, and Tr6 have emitters which are grounded respectively. The three-phase brushless motor 11 includes the magnet rotor 15 and the stator 14 provided with the coils 14A, 14B, and 14C forming the U phase, the V phase, and the W phase respectively. The coils 14A, 14B, and 14C of the U, V, and W phases have, at one ends, a common terminal to which all the phase coils are connected. At the other ends, the U phase coil 14A has a terminal connected to a common connection point of the first and second transistors Tr1 and Tr2, the W phase coil 14C has a terminal connected to a common connection point of the third and fourth transistors Tr3 and Tr4, and the V phase coil 14B has a terminal connected to a common connection point of the fifth and sixth transistors Tr5 and Tr6. Each base of the transistors Tr1 to Tr6 is connected to the control circuit 12. One terminal of the control circuit 12 is connected to the power supply terminal (+Ba) and the other terminal thereof is grounded. The control circuit 12 in this embodiment is constituted by a custom IC.

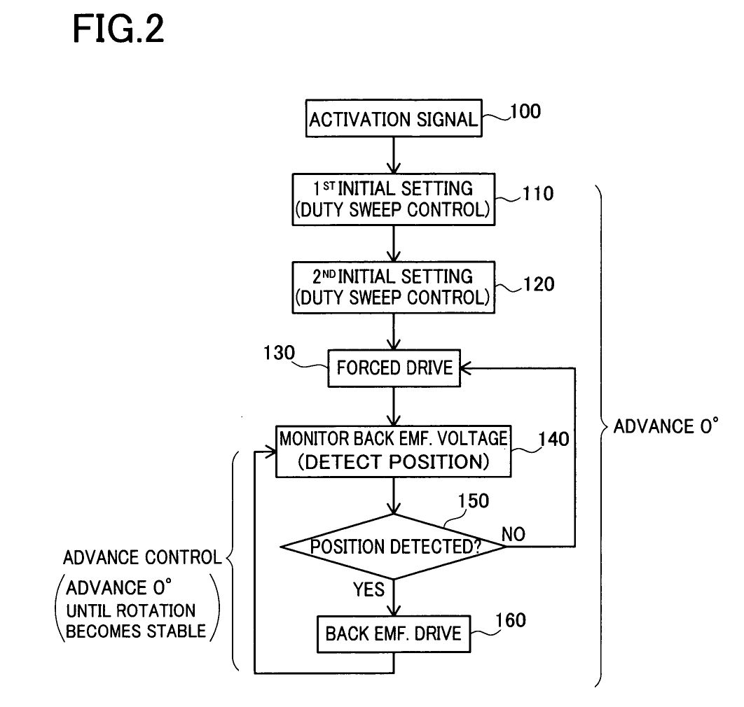

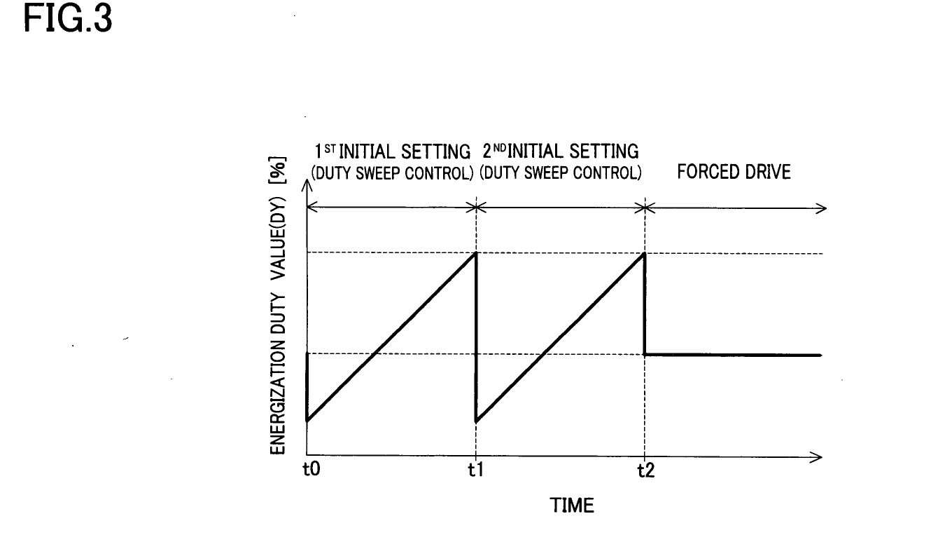

FIG. 2 is a conceptual diagram showing the control logic to be executed by the control circuit 12. FIG. 3 is a time chart showing variations in energization duty value to each phase coil 14A to 14C. According to this control logic, when an activation command signal is inputted by turn-on of an ignition switch of an engine in step 100, the control circuit 12 firstly performs a first initial setting (duty sweep control) in step 110. In other words, the control circuit 12 gradually changes an energization duty value DY with respect to each phase coil 14A to 14C. In this embodiment, as shown from time t0 to time t1 in FIG. 3, a value of the energization duty value DY is gradually increased from a short time (a small energization ratio) to a long time (a large energization ratio). Subsequently, the control circuit 12 executes second initial setting (duty sweep control) in step 120. Specifically, the control circuit 12 gradually changes the energization duty value DY to each phase coil 14A to 14C again in the same manner as in the first time. In this embodiment, as shown by times t1 to t2 in FIG. 3, a value of the energization duty value DY is gradually increased from a short time (a small energization ratio) to a long time (a large energization ratio) again. By performing the initial setting twice as above, the magnet rotor 15 is set in a predetermined initial position.

In step 130, thereafter, the control circuit 12 executes the “forced drive” control. As shown after time t2 in FIG. 3, under the condition that the energization duty value DY is constant (herein, 50%) and the magnet rotor 15 is set in the predetermined initial position, a specific phase of the phase coils 14A to 14C is energized.

In step 140, the control circuit 12 detects the position of the magnet rotor 15 by monitoring back electromotive force voltage. In step 150, successively, the control circuit 12 determines whether or not the position of the magnet rotor 15 has been detected. If it is determined that the position has not been detected, the control circuit 12 returns to step 130 for the forced drive control.

To the contrary, if it is determined that the position has been detected in step 150, the control circuit 12 executes the “back electromotive force drive” control in step 160 and then returns to step 140 for monitoring the back electromotive force voltage. To execute the back electromotive force drive control, the control circuit 12 performs “advance control” for advancing energization timing to each phase coil 14A to 14C as shown in FIG. 2. In this advance control, the timing advance is set at “0°” until rotation becomes stable, that is, the timing advance is disabled. The details of this advance control will be mentioned later. To perform controls other than the back electromotive force drive control, the energization timing advance to each phase coil 14A to 14C is not permitted and is kept at “0°”.

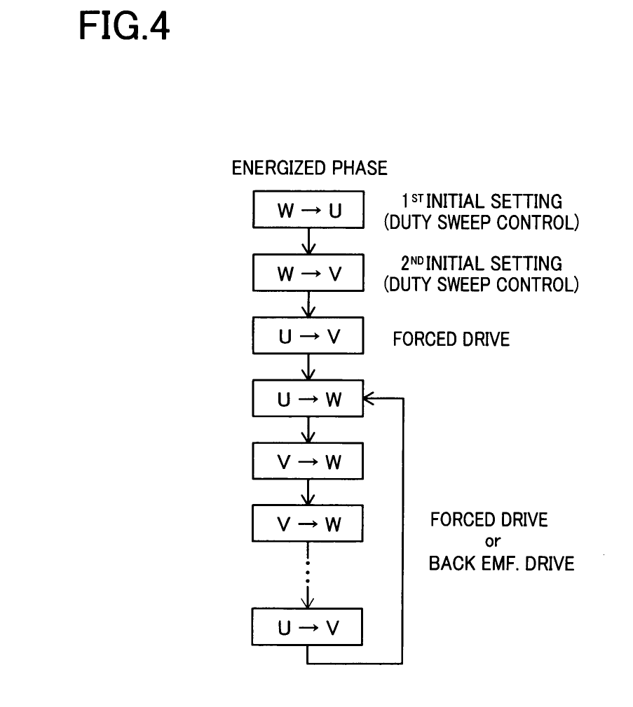

FIG. 4 is a flowchart showing changes of energized phases corresponding to the control logic of FIG. 2. In this embodiment, the first initial setting (duty sweep control) is carried out by performing energization from W phase to U phase, that is, from the coil 14C to the coil 14A. The second initial setting (duty sweep control) is conducted by performing energization from W phase to V phase, that is, from the coil 14C to the coil 14B. In the forced drive mode, the energization from U phase to V phase, that is, from the coil 14A to the coil 14B is performed. In the subsequent forced or back electromotive force drive mode, the coils 14A to 14C of the U to W phases are energized in the direction and order of “U→W”, “V→W”, “V→W”, . . . “U→V”.

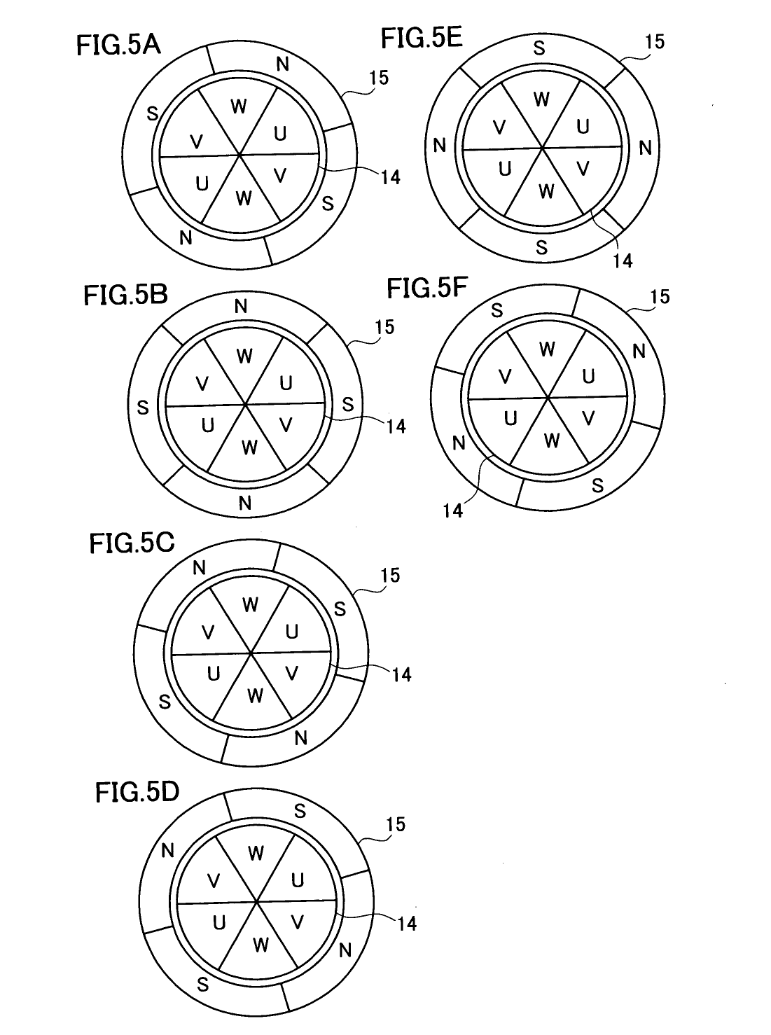

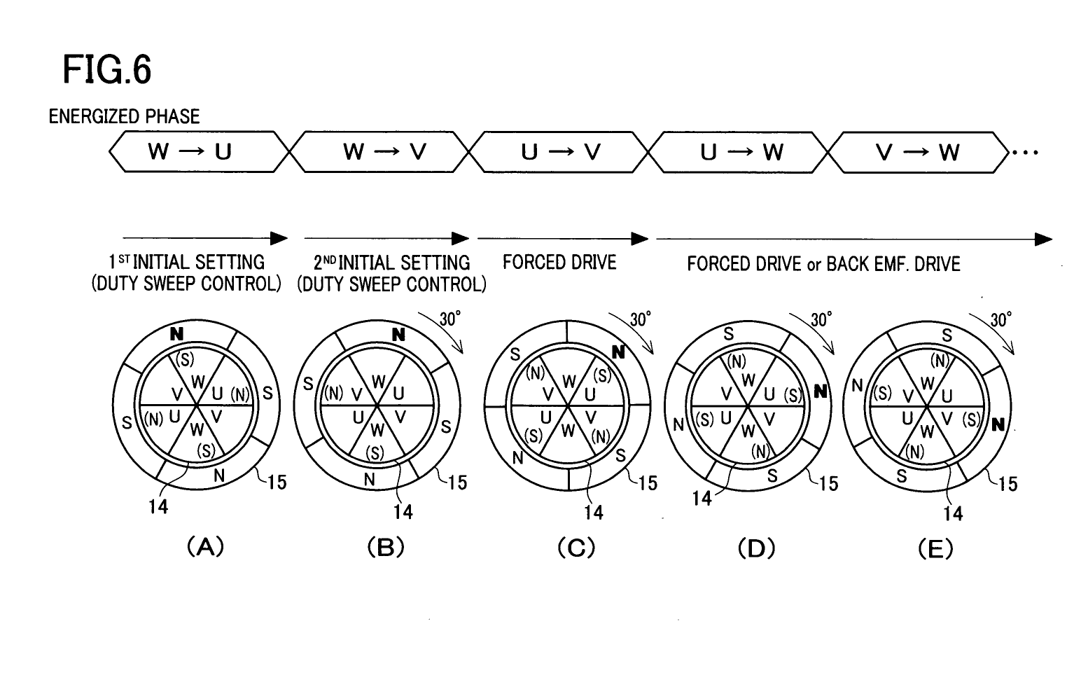

Herein, an explanation is given to the positional relationship between the magnet rotor 15 and the stator 14 including the U, V, W phases from the first initial setting (duty sweep control) until the forced or back electromotive force drive mode is executed. FIGS. 5A to 5F are conceptual diagrams showing conceivable positional relationships between the stator 14 and the magnet rotor 15 during a motor stop state. FIG. 6 is a conceptual diagram showing changes of energized phases in association with the above control logic and changes in the positional relationship between the stator 14 and the magnet rotor 15. When the first initial setting (duty sweep control) is started from the motor stop state shown in FIGS. 5A to 5F, the magnet rotor 15 rotates to slowly move into a state (A) in FIG. 6. Then, the second initial setting (duty sweep control) is carried out to further rotate the magnet rotor 15 by 30° into a state (B) in FIG. 6. Subsequently, the forced drive control is performed, thereby additionally rotating the magnet rotor 15 by 30° into a state (C) in FIG. 6. The forced or back electromotive force drive control is then carried out to further rotate the magnet rotor 15 in steps of 30° to come to the states (D) and (E) in FIG. 6.

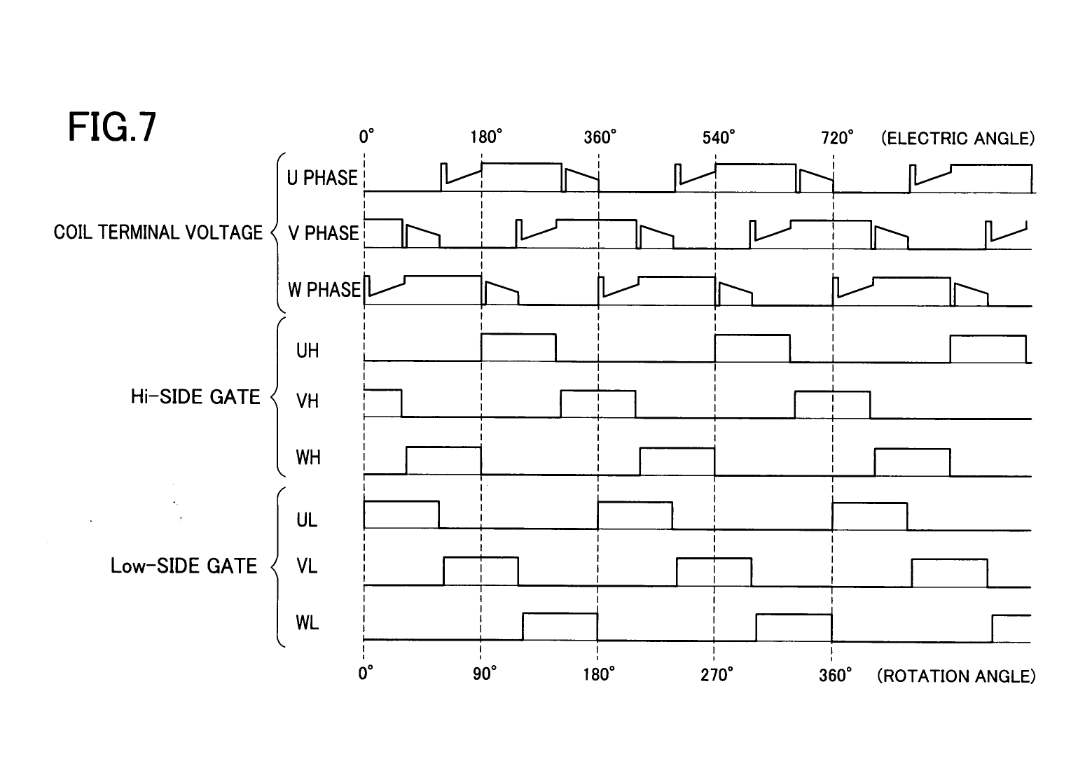

Here, the aforementioned “back electromotive force drive” control is explained below. FIG. 7 is a time chart showing the timing of energization of each phase executed by the control circuit 12 during the back electromotive force drive control and variations in back electromotive force voltage in each phase. The control circuit 12 controls energization of each base (gate) of the transistors Tr1 to Tr6 of the drive circuit 13 to control energization of the coils 14A to 14C of the U to W phases. In FIG. 7, the words “UH, VH, WH” indicate a Hi-side gate for setting the U, V, and W phases at a high level and the words “UL, VL, WL” indicate a Low-side gate for setting the U, V, and W phases at a low level. As shown in FIG. 7, when energization of the Hi-side gate and the Low-side gate is controlled, the coils 14A to 14C of the U to W phases are energized selectively, generating back electromotive force voltage in each coil 14A to 14C.

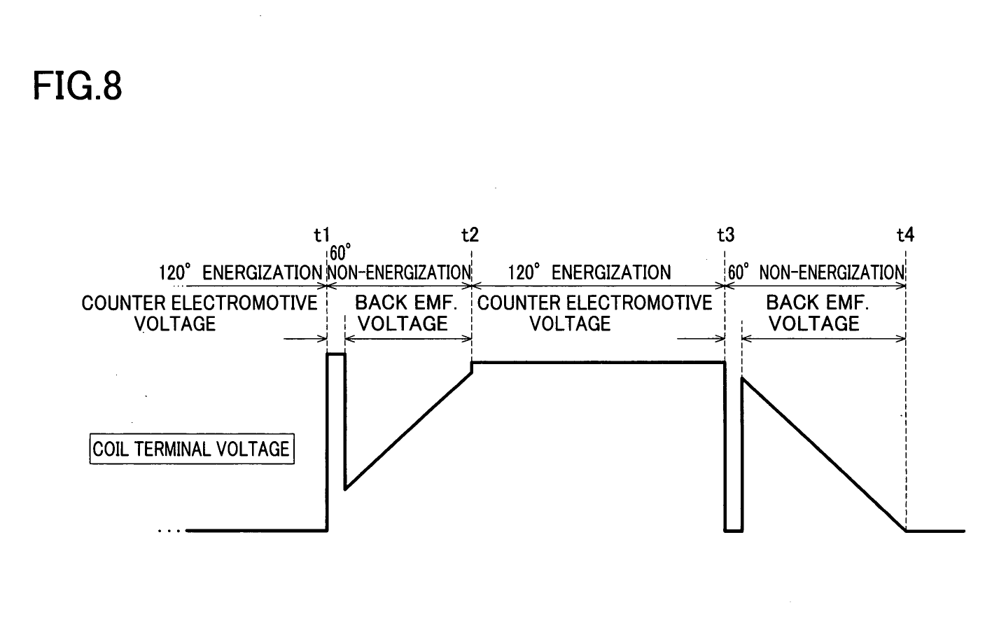

FIG. 8 is a time chart showing variations in terminal voltage of each of the coils 14A to 14C of the U to W phases. As is found from this chart, each coil 14A to 14C is subjected to “120° energization” and “60° non-energization” alternately. In FIG. 8, when the coil is switched to a non-energized state at time t1, a positive counter electromotive force is first generated as pulse-shaped voltage and subsequently back electromotive force voltage increases. During a period from switching to energization at time t2 up to switching to non-energization at time t3, the voltage stays positive at a constant level. When the coil is switched to a non-energized state at time t3, a negative counter electromotive force is generated as pulse-shaped voltage and subsequently inducted voltage decreases. Herein, the counter electromotive force represents a voltage that occurs in an armature of an electric motor which rotates in a magnetic field, and its polarity is the reverse of the polarity of electric force to be supplied to the armature. When the coil is switched to the energized state at time t4, the voltage stays negative at a constant level. The control circuit 12 detects the rotor position by utilizing the back electromotive force voltage generated following the counter electromotive voltage. The control circuit 12 controls energization of the coils 14A to 14C of the U, V, and W phases based on the rotor position detected as above. Specifically, the control circuit 12 causes the magnet rotor 15 to rotate by sequentially switching energization of the coils 14A to 14C of the U to W phases of the stator 15. The control circuit 12 further detects the rotor position based on the back electromotive force voltage generated in each phase coil 14A to 14C as above to perform the back electromotive force drive control for controlling the energization of each phase coil 14A to 14C based on the detected rotor position.

Here, assuming that for example the energization timing of each phase coil 14A to 14C with respect to transit of coil terminal voltage in each phase coil as shown in FIG. 7 is a reference timing, the advance control in the back electromotive force drive mode explained with reference to FIG. 2 means the control to advance the energization timing to be earlier than the reference timing. The advance control value from the reference timing may be determined in for example a range of “5° to 15°”.

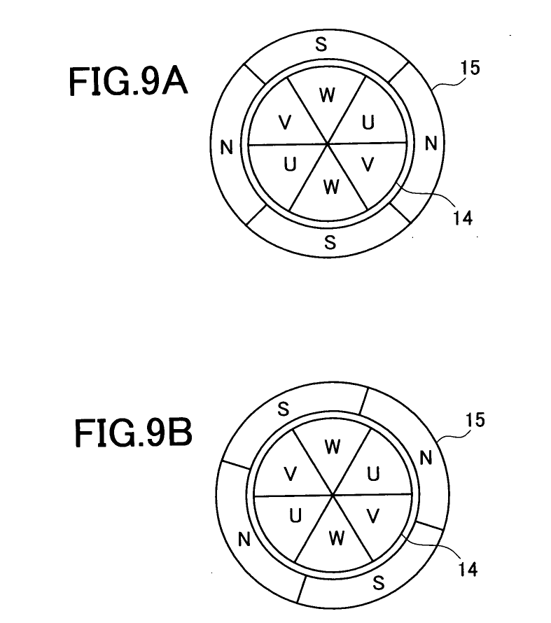

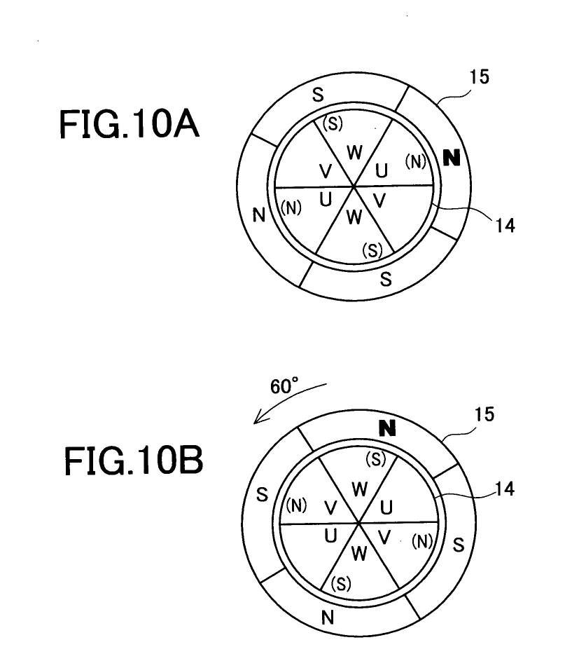

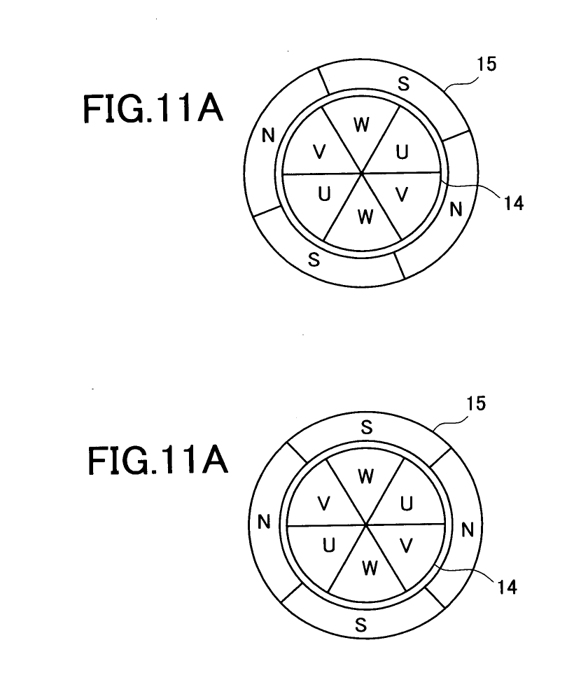

According to the brushless motor driving apparatus in this embodiment explained above, the initial setting is carried out twice prior to the back electromotive force drive control so that the energization duty to each phase coil 14A to 14C of the stator 14 is swept twice. The magnet rotor 15 can be slowly rotated to the predetermined initial position where it is ready to be activated (forcibly driven) with respect to the stator 14. Since the initial setting is continuously conducted twice, the magnet rotor 15 will not stop at the “dead point” by the second sweep control. The “dead point” is a position where the magnet rotor 15 does not rotate even if the forced drive control is conducted later. For example, it is assumed that the positional relationship between the stator 14 and the magnet rotor 15 during the motor stop is as shown in FIGS. 9A and 9B (FIGS. 5E and 5F). At that time, when in the first initial setting is performed for the phase energization “W→U” to execute the first sweep control, the positional relationship between the stator 14 and the magnet rotor 15 may come to a dead point position shown in FIG. 10. However, the second initial setting is performed thereafter for the phase energization “W→V”. Consequently, as shown in FIG. 10B, the magnet rotor 15 is reversely rotated by “60°”. The positional relation between the stator 14 and the magnet rotor 15 comes to the same as that shown in FIG. 6B. Specifically, this position is a state where the forced drive control is enabled later by the phase energization “U→V”. Here, there is a risk that the magnet rotor 15 stops at the dead point by the phase energization “W→V” in the second initial setting. However, the conceivable position of the magnet rotor 15 prior to the energization of “W→V” is the state shown in either of FIGS. 11A and 11B. This state differs from the state after the phase energization “W→U” in the first initial setting. In other words, particularly, the three-phase brushless motor 11 is subjected to the continuous double initial settings, so that the second sweep control can prevent the magnet rotor 15 from stopping at the dead point. Accordingly, the three-phase brushless motor 11 particularly can be placed in an activatable state even though the magnet rotor 15 is stopped at any position.

In this embodiment, the energization of each phase coil 14A to 14C is performed by a three-phase full-wave drive system. Thus, by execution of the aforementioned double initial settings, the magnet rotor 15 can be placed efficiently in such a positional relationship with the stator 14 that the magnet rotor 15 is ready to be forcibly driven. Therefore, particularly the three-phase brushless motor 11 is efficiently placed in an activatable state.

In this embodiment, the sweep control in the first and second initial settings is to gradually change the energization duty from a short time to a long time. Thus, the magnet rotor 15 will reliably start to rotate from the stop state. It is therefore possible to reliably place the brushless motor 11 in an activatable state.

In this embodiment, after the second initial setting, that is, after the magnet rotor 15 is set to the predetermined initial position but before the back electromotive force drive control is carried out, the forced drive control is executed to forcibly energize the coils (here, 14A and 14B) of a specified phase (U→V). Accordingly, since the coils (14A and 14B) of the specified phase are energized while the magnet rotor 15 is set in the predetermined initial position, the magnet rotor 15 will start to rotate reliably. This makes it possible to surely activate the brushless motor 11 before execution of the back electromotive force drive control. The energization duty value DY during the forced drive control and a certain period until the rotation of the magnet rotor 15 becomes stable is set at a predetermined fixed value (in this case, “50%”). It is therefore possible to restrain the activation energy of the magnet rotor 15 to a moderate degree and hence prevent the magnet rotor 15 from excessively rotating to pass over a target position. In this regard, the magnet rotor 15 can be prevented from falling out of step at the time of activation.

According to this embodiment, in the back electromotive force drive control, the energization timing of each phase coil 14A to 14C is advanced. This enhances the followability of the magnet rotor 15 in rotating to the energization timing of each phase coil 14A to 14C. On the other hand, during the forced drive control and the certain period until the rotation of the magnet rotor 15 becomes stable, the energization timing of each phase coil 14A to 14C is not advanced. This will not deteriorate the followability of the magnet rotor 15 in rotating to the energization timing of each phase coil 14A to 14C. Consequently, the magnet rotor 15 can be rotated stably upon activation and also rotated efficiently after activation to provide improved motor efficiency.

According to this embodiment, the three-phase brushless motor 11 is used as a power source of the water pump 21 to be mounted in a hybrid electric vehicle or an electric vehicle. Therefore, the brushless motor 11 of the water pump 21 used in the hybrid electric vehicle or the electric vehicle can provide the operations and advantages similar to above.

The present invention is not limited to the above embodiment(s) and may be embodied in other specific forms without departing from the essential characteristics thereof.

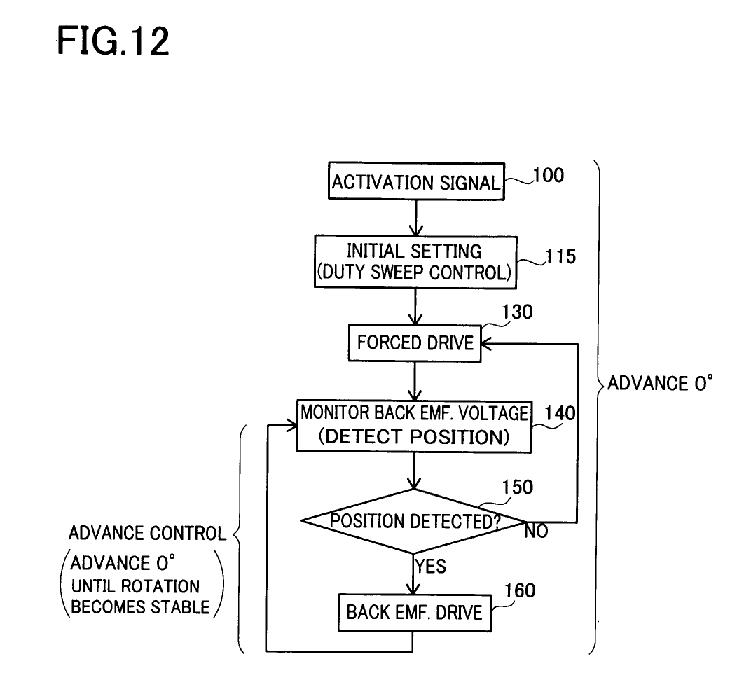

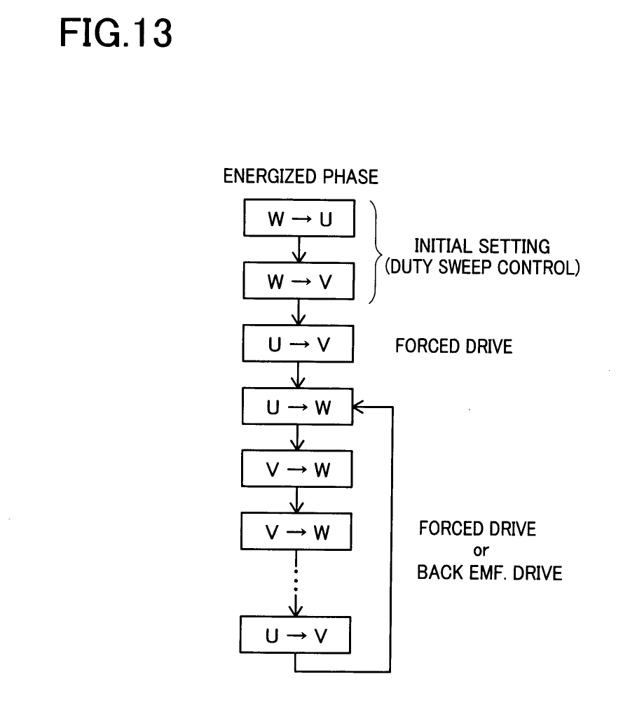

In the above embodiment, the double, i.e. first and second, initial settings are carried out before the first forced drive control. Alternatively, the initial setting may be carried out only once. Specifically, instead of the steps 110 and 120 in FIG. 2, a single initial setting (duty sweep control) may be performed in step 115 prior to the forced drive control in the step 130 as shown in FIG. 12. Changes of energized phase corresponding to the control logic are as shown in the flowchart of FIG. 13.

In the present embodiment, the driving apparatus of the invention is embodied as the three-phase brushless motor 11. An alternative is to embody the driving apparatus as a brushless motor having the number of phases other than three.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A brushless motor driving apparatus for driving a brushless motor comprising a stator including coils of multiple phases and a magnet rotor provided corresponding to the stator, the apparatus being arranged to rotate the magnet rotor by sequentially switching energization of each phase coil, detect a position of the magnet rotor based on back electromotive force voltage generated in each phase coil, and control the energization of each phase coil based on the detected position,
wherein the apparatus is configured to energize each phase coil under duty control and, before the back electromotive force control, perform initial setting for sweeping energization duty with respect to each phase coil to set the magnet rotor in a predetermined initial position.

2. A brushless motor driving apparatus for driving a brushless motor comprising a stator including coils of three phases and a magnet rotor provided corresponding to the stator?, the apparatus being arranged to rotate the magnet rotor by sequentially switching energization of each phase coil, detect a position of the magnet rotor based on back electromotive force voltage generated in each phase coil, and control the energization of each phase coil based on the detected position,
wherein the apparatus is configured to energize each phase coil under duty control and, before the back electromotive force control, perform initial setting at least twice for sweeping energization duty with respect to each phase coil to set the magnet rotor in a predetermined initial position.

3. The brushless motor driving apparatus according to claim 2, wherein the energization of each phase coil is carried out by a three-phase full-wave drive system.

4. The brushless motor driving apparatus according to claim 1, wherein the sweep control in the initial setting is configured to gradually change the energization duty from a short time to a long time.

5. The brushless motor driving apparatus according to claim 2, wherein the sweep control in the initial setting is configured to gradually change the energization duty from a short time to a long time.

6. The brushless motor driving apparatus according to claim 3, wherein the sweep control in the initial setting is configured to gradually change the energization duty from a short time to a long time.

7. The brushless motor driving apparatus according to claim 1, wherein the driving apparatus is arranged to carry out forced drive control to forcibly energize a coil of a specific one of the phases after the initial setting is carried out but before the back electromotive force drive control is performed.

8. The brushless motor driving apparatus according to claim 2, wherein the driving apparatus is arranged to carry out forced drive control to forcibly energize a coil of a specific one of the phases after the initial setting is carried out but before the back electromotive force drive control is performed.

9. The brushless motor driving apparatus according to claim 3, wherein the driving apparatus is arranged to carry out forced drive control to forcibly energize a coil of a specific one of the phases after the initial setting is carried out but before the back electromotive force drive control is performed.

10. The brushless motor driving apparatus according to claim 4, wherein

11. The brushless motor driving apparatus according to claim 7, wherein an energization duty value during the forced drive control and a certain period until rotation of the magnet rotor becomes stable is a predetermined given value.

12. The brushless motor driving apparatus according to claim 8, wherein an energization duty value during the forced drive control and a certain period until rotation of the magnet rotor becomes stable is a predetermined given value.

13. The brushless motor driving apparatus according to claim 9, wherein an energization duty value during the forced drive control and a certain period until rotation of the magnet rotor becomes stable is a predetermined given value.

14. The brushless motor driving apparatus according to claim 10, wherein an energization duty value during the forced drive control and a certain period until rotation of the magnet rotor becomes stable is a predetermined given value.

15. The brushless motor driving apparatus according to claim 7, wherein the driving apparatus is arranged to carry out the back electromotive force drive control by advancing energization timing of each phase coil but, during the forced drive control and a certain period until rotation of the magnet rotor becomes stable, to carry out the back electromotive force drive control without advancing the energization timing of each phase coil.

16. The brushless motor driving apparatus according to claim 11, wherein the driving apparatus is arranged to carry out the back electromotive force drive control by advancing energization timing of each phase coil but, during the forced drive control and a certain period until rotation of the magnet rotor becomes stable, to carry out the back electromotive force drive control without advancing the energization timing of each phase coil.

17. The brushless motor driving apparatus according to claim 1, wherein the brushless motor is a power source of a water pump to be used in one of a hybrid electric vehicle and an electric vehicle.

18. The brushless motor driving apparatus according to claim 2, wherein the brushless motor is a power source of a water pump to be used in one of a hybrid electric vehicle and an electric vehicle.

19. The brushless motor driving apparatus according to claim 3, wherein the brushless motor is a power source of a water pump to be used in one of a hybrid electric vehicle and an electric vehicle.

20. The brushless motor driving apparatus according to claim 4, wherein the brushless motor is a power source of a water pump to be used in one of a hybrid electric vehicle and an electric vehicle.
